(19) United States
(12) Patent Application Publication
(10) Pub. No.: US 2016/0115375 A1
(43) Pub. Date: Apr. 28, 2016

(54) Proppants and Anti-Flowback Additives Including Compositions Comprising Calcium, Multi-Foil Cross Sections, and/or Size Ranges

(71) Applicant: IMERYS OILFIELD MINERALS, INC., Roswell, GA (US)

(72) Inventors: JOHAN LORICOURT, VILLACH (AT); JEAN-ANDRE ALARY, L'isle Sur La Sorge (FR); DAVID GUETTA, HOUSTON, TX (US); CHRISTOPHER STEPHENSON, HOUSTON, TX (US)

(21) Appl. No.: 14/895,452

(22) PCT Filed: Jun. 2, 2014
(86) PCT No.: PCT/US14/40536

§ 371 Date: Dec. 2, 2015

Related U.S. Application Data
(60) Provisional application No. 61/830,487, filed on Jun. 3, 2013.
(60) Provisional application No. 61/865,682, filed on Aug. 14, 2013.

(30) Foreign Application Priority Data
Aug. 2, 2013 (EP) 13290186.9

(51) Int. Cl. C09K 8/80

(52) U.S. Cl. CPC C09K 8/80

(57) ABSTRACT

A proppant may include a sintered ceramic, wherein the sintered ceramic has a composition including an alumina (Al₂O₃) content ranging from about 60% to about 78% by weight, an iron oxide (Fe₂O₃) content ranging from about 5% to about 20% by weight, a silica (SiO₂) content ranging from about 1% to about 10% by weight, a titania (TiO₂) content ranging from about 2% to about 8% by weight, and a combined iron oxide and titania content of at least about 11% by weight. A proppant may include a sintered ceramic. The sintered ceramic may have a composition including a calcium oxide (CaO) content ranging from about 1% to about 5% by weight. A rod-shaped proppant may include a sintered ceramic having an aspect ratio ranging from about 1.5 to about 3, an apparent specific gravity ranging from about 2.0 to about 4.0, and a pack porosity of greater than 49%.

### CLAIM OF PRIORITY

This PCT International Application claims the benefit of priority of U.S. Provisional Application Nos. 61/830,487, filed Jun. 3, 2013, 61/865,682, filed Aug. 14, 2013, and European Patent Application No. 13290186.9, filed Aug. 2, 2013, the subject matter of all of which is incorporated herein by reference in their entireties.

### FIELD OF THE DISCLOSURE

The present disclosure relates to proppants and anti-flowback additives for use in fracturing operations, and more particularly, to proppants and anti-flowback additives having high compressive strength and good conductivity.

### BACKGROUND OF THE DISCLOSURE

Naturally occurring deposits containing oil and natural gas are located throughout the world. Given the porous and permeable nature of the subterranean structure, it is possible to bore into the earth and set up a well where oil and natural gas are pumped out of the deposit. These wells are large, costly structures that are typically fixed at one location. As is often the case, a well may initially be very productive, with the oil and natural gas being pumpable with relative ease. As the oil or natural gas near the well bore is removed from the deposit, other oil and natural gas may flow to the area near the well bore so that it may be pumped as well. However, as a well ages, and sometimes merely as a consequence of the subterranean geology surrounding the well bore, the more remote oil and natural gas may have difficulty flowing to the well bore, thereby reducing the productivity of the well.

To address this problem and to increase the flow of oil and natural gas to the well bore, a technique may be employed of fracturing the subterranean area around the well to create more paths for the oil and natural gas to flow toward the well bore. This fracturing may be performed by hydraulically injecting a fracturing fluid at high pressure into the area surrounding the well bore. This fracturing fluid is thereafter removed from the fracture to the extent possible so that it does not impede the flow of oil or natural gas back to the well bore. Once the fracturing fluid is removed, however, the fractures may tend to collapse due to the high compaction pressures experienced at well-depths, which may exceed 20,000 feet.

To reduce the likelihood of the fractures closing, a propping agent, also known as a “proppant,” may be included in the fracturing fluid, so that the fracturing fluid as possible may be removed from the fractures while leaving the proppant behind to hold the fractures open. As used in this application, the term “proppant” refers to any non-liquid material that is present in a proppant pack and provides structural support in a propped fracture. “Anti-flowback additive” refers to any material that is present in a proppant pack and reduces the flowback of proppant particles but still allows for production of oil at desired rates. The terms “proppant” and “anti-flowback additive” are not necessarily mutually exclusive, so a single particle type may meet both definitions. For example, a particle may provide structural support in a fracture and it may also be shaped to have anti-flowback properties, allowing it to meet both definitions.

Because there may be extremely high closing pressures in fractures, it may be desirable to provide proppants and anti-flowback additives that have a high crush resistance. For example, the useful life of the well may be shortened if the proppant particles break down, allowing the fractures to collapse and/or clog with “fines” created by the broken down proppant particles. For this reason, it may be desirable to provide proppants that are resistant to breakage, even under high crush pressures.

In addition, it may also be desirable to provide a proppant or anti-flowback additive that packs well with other proppant particles and the surrounding geological features, so that the nature of this packing of particles does not unduly impede the flow of the oil and natural gas through the fractures. For example, if the proppant particles become too tightly packed and create low porosity, they may actually inhibit the flow of the oil or natural gas to the well bore rather than increase it.

The nature of the packing may also affect the overall turbulence generated as the oil or natural gas flows through the fractures. Too much turbulence may increase the flowback of the proppant particles from the fractures toward the well bore, which may undesirably decrease the flow of oil and natural gas, contaminate the well, cause abrasion to the equipment in the well, and/or increase the production cost as the proppants that flow back toward the well must be removed from the oil and natural gas. In addition, too much turbulence may also increase a non-Darcy flow effect, which may ultimately result in decreased conductivity of the flow of oil or natural gas.

The shape of the proppant particles may have a significant impact on how they pack with other proppant particles and the surrounding fractures. For example, the shape of the proppant particles may significantly alter the permeability and/or conductivity of a proppant pack in a fracture. Different shapes of the same material may result in different strengths and resistance to closure stress. Thus, it may be desirable to provide the proppant with a shape or shapes that provide high strength and a packing tendency that results in increased flow of oil or natural gas to the well bore. The optimum shape may differ for different depths, closure stresses, geologies of the surrounding earth, and materials intended to be extracted from the well bore.

It is conventionally believed in the industry that spherical pellets of uniform size are the most effective proppant body shape to maximize the permeability of the fracture. Indeed, the American Petroleum Institute's (“API's”) description of the proppant qualification process has a section dedicated to the evaluation of roundness and sphericity of the proppants as measured on the Krumbein scale.

Another property that may affect a proppant's usefulness is how quickly the proppant particles settle both in the fracturing fluid and once the proppant particles are within in the fractures. For example, a proppant that quickly settles may not reach remote, desired propping locations in the fracture, resulting in an undesirably low level of proppants in some remote fracture locations, such as locations high or deep enough in the fracture to maximize the presence of the proppant in the pay zone (i.e., the zone in which oil or natural gas flows back to the well). This may reduce the effectiveness of the fracturing operation. Thus, it may be desirable to provide a proppant that disperses relatively uniformly throughout all portions of the fracture.

It may also be desirable to provide a proppant that is relatively acid-tolerant, as acids may often be used in oil and natural gas wells and may undesirably alter the properties of the proppant. For example, hydrofluoric acid may sometimes be used to treat oil wells, and thus, it may be desirable to provide a proppant that is resistant to such an acid.

Still another property to consider for a proppant is its surface texture. For example, a surface texture that enhances, or at least does not inhibit, the conductivity of the oil or natural gas through the fractures may be desirable. Smoother surfaces may offer certain advantages over rough surfaces, such as reduced tool wear and a better conductivity, but porous surfaces may be desirable for some applications, for example, where proppants having a reduced density.

As resources become more scarce, the search for oil and natural gas may involve penetration into deeper geological formations, and the recovery of the such resources may become increasingly difficult. Therefore, there may be a desire to provide proppants and anti-flowback additives that have an excellent conductivity and permeability under extreme conditions. In addition, there may be a desire to provide proppants and anti-flowback additives formed from less costly or more prevalent materials that still provide one or more desirable characteristics for propping fractures in modern wells.

### SUMMARY OF THE DISCLOSURE

In the following description, certain aspects and embodiments will become evident. It should be understood that the aspects and embodiments, in their broadest sense, could be practiced without having one or more features of these aspects and embodiments. It should be understood that these aspects and embodiments are merely exemplary.

According to one aspect, a proppant may include a sintered ceramic, wherein the sintered ceramic has a composition including an alumina (Al₂O₃) content ranging from about 60% to about 78% by weight, an iron oxide (Fe₂O₃) content ranging from about 5% to about 20% by weight, a silica (SiO₂) content ranging from about 1% to about 10% by weight, a titania (TiO₂) content ranging from about 2% to about 8% by weight, and a combined iron oxide and titania content of at least about 11% by weight. For example, the combined iron oxide and titania content may be at least about 12% by weight, or at least about 15% by weight. According to another aspect, the combined iron oxide and titania content may not be greater than about 25% by weight. For example, the combined iron oxide and titania content may range from about 12% to about 20% by weight. The chemical composition of the proppants and anti-flowback additives may be measured according to known methods, including via an XFR analysis.

According to another aspect, the proppant may include proppant particles having a length and a cross-sectional diameter, and wherein the proppant particles may have an aspect ratio of length to cross-sectional diameter ranging from about 1.5 to about 3. According to another aspect, the proppant may have an apparent specific gravity ranging from about 2.0 to about 4.0. According to another aspect, the proppant may have an American Petroleum Institute (API) crush value of less than 22% fines at 15,000 psi. According to a further aspect, the proppant may have a pack porosity of greater than 49%. According to another aspect, the proppant may have a multifoil-shaped cross-section. According to a further aspect, the proppant may have a crush strength of at least about 100 MPa.

According to a further aspect, a proppant may include a sintered ceramic. The sintered ceramic may have a composition including an alumina content ranging from about 60% to about 78% by weight, an iron oxide content ranging from about 5% to about 20% by weight, a silica content ranging from about 1% to about 10% by weight, and a calcium oxide (e.g., CaO) content ranging from about 1% to about 5% by weight. For example, the alumina content may range from about 70% to about 78% by weight. According to another aspect, the iron oxide content may range from about 8% to about 15% by weight. According to a further aspect, the titania content may range from about 2% to about 8% by weight. According to a further aspect, the proppant may have a combined iron oxide and titania content ranging from about 12% to about 20% by weight. According to a further aspect, the proppant includes proppant particles having a length and a cross-sectional diameter, and wherein the proppant particles may have an aspect ratio of length to cross-sectional diameter ranging from about 1.5 to about 3. According to some aspects, the proppant may have an apparent specific gravity ranging from about 2.0 to about 4.0. According to some aspects, the proppant may have an API crush value of less than 22% fines at 15,000 psi. According to some aspects, the proppant may have a pack porosity of greater than 49%. According to some aspects, the proppant may have a multifoil-shaped cross-section. According to some aspects, the proppant may have a crush strength of at least about 100 MPa.

According to a further aspect, a ceramic precursor composition suitable for use in making a proppant may include at least about 80% by weight on a dry basis of a bauxite ore comprising an alumina content ranging from about 55% to about 78% by weight and an iron oxide content ranging from about 5% to about 20% by weight. The ceramic precursor composition may also include an alkaline earth carbonate content ranging from about 1% to about 5% by weight. According to some aspects, the ceramic precursor composition may also include a titania content ranging from about 2% to about 8% by weight. According to some aspects, the ceramic precursor composition may also include a sufficient alumina content to bring the total alumina content of the ceramic precursor composition into the range of from about 70% to about 78% by weight. According to some aspects, the iron oxide content may range from about 8% to about 15% by weight. According to some aspects, the proppant may have a combined iron oxide and titania content ranging from about 12% to about 20% by weight.

According to another aspect, a method for making a sintered ceramic proppant may include forming a ceramic precursor composition by admixing: (i) at least about 80% by weight on a dry basis of a bauxite ore having an alumina content ranging from about 55% to about 78% by weight and an iron oxide content ranging from about 5% to about 20% by weight, and (ii) about 1% to about 5% by weight of an alkaline earth carbonate. The method may also include shaping the ceramic precursor composition into a desired shape, and sintering the shaped ceramic precursor composition to produce a sintered ceramic proppant. According to some aspects, the ceramic precursor composition may further include a titania content ranging from about 2% to about 8% by weight. According to some aspects, the ceramic precursor composition may have an iron oxide content ranging from about 8% to about 15% by weight. According to some aspects, the shaped ceramic precursor may have a Krumbein sphericity of at least about 0.5. According to some aspects, the shaped ceramic precursor has a Krumbein roundness of at least about 0.5. According to some aspects, the shaped ceramic precursor is rod-shaped. For example, the rod-shaped ceramic precursor may have a multi-foil shaped cross-section.

According to another aspect, a rod-shaped proppant may include a sintered ceramic. The proppant may have an aspect ratio ranging from about 1.5 to about 3, an apparent specific gravity ranging from about 2.0 to about 4.0, an API crush value of less than 22% fines at 15,000 psi, and a pack porosity of greater than 49%. According to another aspect, the proppant may have a regular polygonal-shaped cross-section. For example, the proppant may have a hexagonal-shaped cross-section. According to some aspects, the proppant may have a multifoil-shaped cross-section. For example, the proppant may have a trefoil-shaped cross-section, and/or a sexfoil-shaped cross-section. According to some aspects, the proppant may have a cross-sectional shape selected from the group consisting of quatrefoil, cinquefoil, huitfoil, or higher multifoil.

According to another aspect, the proppant may have an aspect ratio ranging from about 1.5 to about 2. According to another aspect, the proppant may have an apparent specific gravity ranging from about 2.0 to about 4.0. According to another aspect, the proppant may have an apparent specific gravity ranging from about 3.2 to about 3.8. According to another aspect, the proppant may have an API crush value of less than 20% fines at 15,000 psi. According to another aspect, the proppant may have a pack porosity of greater than 50%. According to another aspect, the proppant may have an average diameter ranging from about 0.5 millimeter to about 2 millimeters. According to another aspect, the proppant may have an average length of about 2 millimeters to about 4 millimeters. According to another aspect, the proppant may have a bulk density ranging from about 0.5 g/cm³ to about 2.5 g/cm³. For example, the proppant may have a bulk density ranging from about 1.2 g/cm³ to about 1.9 g/cm³. According to another aspect, the proppant may be coated with a natural or synthetic coating.

According to another aspect, the proppant may include a composition selected from the group consisting of sintered bauxite, sintered kaolin, sintered meta-kaolin, sintered pure or technical grade alumina, sintered alumina-containing slag, and sintered zirconia.

According to another aspect, the proppant may include rod-shaped proppant particles and substantially spherical proppant particles.

According to another aspect, the proppant may have a crush strength of at least about 200 MPa. For example, the proppant may have a crush strength of at least about 250 MPa.

According to another aspect, a proppant may include a sintered ceramic, wherein the proppant has an aspect ratio ranging from about 1.5 to about 3, and a multifoil-shaped cross-section. For example, the multifoil-shaped cross-section may be at least one of a trefoil, a quatrefoil, a cinquefoil, a sexfoil, a huitfoil, or a higher multi-foil.

According to another aspect, the proppant particles may have a length, and at least about 90% by weight of the proppant particles may have a length of less than about 10 millimeters. For example, at least about 90% by weight of the proppant particles may have a length of less than about 7 millimeters, less than about 5 millimeters, less than about 4 millimeters, less than about 3.75 millimeters, less than about 3.5 millimeters, less than about 3 millimeters, less than about 2.5 millimeters, less than about 2 millimeters, or less than about 1.5 millimeters.

According to another aspect, a proppant may include a plurality of proppant particles having a composition comprising a sintered ceramic. The proppant particles may have a length, and the length of the proppant particles may range from about 2 millimeters to about 4 millimeters. For example, the length of the proppant particles may range from about 3 millimeters to about 4 millimeters, or from about 3.5 to about 4 millimeters.

According to another aspect, a proppant may include a plurality of proppant particles having a composition comprising a sintered ceramic. The proppant particles may have a length, and at least about 10% by weight of the proppant particles may have a length of greater than about 1.2 millimeters. For example, at least about 10% by weight of the proppant particles may have a length of greater than about 1.5 millimeters, greater than about 1.7 millimeters, or greater than about 2.0 millimeters.

According to another aspect, a proppant may include a plurality of proppant particles having a composition including a sintered ceramic, with the proppant particles having a length, such that the proppant particles may have a mean length ranging from about 2 millimeters to about 4 millimeters. For example, the proppant particles may have a mean length ranging from about 2.0 millimeters to about 2.6 millimeters. According to another aspect, the proppant particles may have a mean length ranging from about 2.2 millimeters to about 2.8 millimeters. According to another aspect, the proppant particles may have a mean length ranging from about 2.6 millimeters to about 3.0 millimeters. According to another aspect, the proppant particles may have a mean length ranging from about 2.0 millimeters to about 2.2 millimeters. According to another aspect, the proppant particles may have a mean length ranging from about 2.2 millimeters to about 2.4 millimeters. According to another aspect, the proppant particles may have a mean length ranging from about 2.4 millimeters to about 2.6 millimeters. According to another aspect, the proppant particles may have a mean length ranging from about 2.6 millimeters to about 2.8 millimeters. According to another aspect, the proppant particles may have a mean length ranging from about 2.8 millimeters to about 3.0 millimeters.

According to another aspect, a proppant may include a plurality of proppant particles having a composition including a sintered ceramic, with the proppant particles having a cross-sectional diameter, wherein the proppant particles may have a mean cross-sectional diameter ranging from about 0.1 millimeter to about 2.0 millimeters. For example, the proppant particles may have a mean cross-sectional diameter ranging from about 1.2 millimeters to about 2.0 millimeters, or from about 1.4 millimeters to about 1.5 millimeters. Also, for example, the proppant particles may have a mean cross-sectional diameter ranging from about 0.5 millimeters to about 1.5 millimeters, such as, for example, from about 0.5 millimeters to about 1.0 millimeter, from about 0.6 millimeters to about 1.0 millimeter, from about 0.7 millimeters to about 1.0 millimeter, or from about 0.5 millimeters to about 0.8 millimeters.

According to another aspect, a proppant may include a plurality of proppant particles having a composition including a sintered ceramic, with the proppant particles having a cross-sectional diameter, wherein the proppant particles may have a mean cross-sectional diameter of greater than about 0.4 millimeters. For example, the proppant particles may have a mean cross-sectional diameter of greater than about 0.5 millimeters, or greater than about 1.2 millimeters. Also, for example, the proppant particles may have a mean cross-sectional diameter ranging from about 0.5 millimeters to about 1.5 millimeters, such as from about 0.5 millimeters to about 1.0 millimeters, from about 0.6 millimeters to about 1.0 millimeters, from about 0.7 millimeters to about 1.0 millimeters, or from about 0.5 millimeters to about 0.8 millimeters

According to another aspect, a proppant may include a plurality of proppant particles having a composition including a sintered ceramic, with the proppant particles having a length and a cross-sectional diameter, wherein an aspect ratio of length to cross-sectional diameter of the proppant particles may be less than about 3. For example, the aspect ratio of length to cross-sectional diameter of the proppant particles may be less than about 2.5, less than about 2.0, less than about 1.5, less than about 1.4, less than about 1.2, or less than about 1.1.

According to another aspect, a proppant may include a plurality of proppant particles having a composition including a sintered ceramic, with the proppant particles having a length and a cross-sectional diameter, wherein an aspect ratio of length to cross-sectional diameter of the proppant particles may range from about 1.2 to about 3.0. For example, the aspect ratio of length to cross-sectional diameter of the proppant particles may range from about 1.5 to about 2.5.

According to another aspect, a proppant may include a plurality of proppant particles having a composition including a sintered ceramic, with the proppant particles having a length and a cross-sectional diameter, wherein at least about 10% by weight of the proppant particles may have a length of greater than about the cross-sectional diameter of the respective proppant particles. For example, at least about 10% by weight of the proppant particles may have a length of greater than about 1.1 times the cross-sectional diameter of the respective proppant particles.

According to another aspect, a proppant may include a plurality of proppant particles having a composition including a sintered ceramic, with the proppant particles having a length and a cross-sectional diameter, wherein at least about 90% by weight of the proppant particles may have a length less than about four times the cross-sectional diameter of the respective proppant particles. For example, at least about 90% by weight of the proppant particles may have a length less than about 3.5 times the cross-sectional diameter of the respective proppant particles. For example, at least about 90% by weight of the proppant particles may have a length less than about three times the cross-sectional diameter of the respective proppant particles.

Possible advantages of the disclosed embodiments will be set forth in part in the description which follows, or may be learned by practice of the embodiments.

It is to be understood that both the foregoing general description and the following detailed description are exemplary and explanatory only and are not restrictive of the invention.

The accompanying drawings, which are incorporated in and constitute a part of this specification, illustrate several exemplary embodiments and together with the description, serve to explain the principles of the embodiments.

### BRIEF DESCRIPTION OF THE DRAWINGS

FIG. 1 is a graph showing pack porosity as a function of the amount of fines for four exemplary tested proppants having different cross-sectional shapes.

FIG. 2 is a graph showing the length distribution of exemplary rod-shaped proppants subjected to API crush tests.

FIG. 3 is a graph showing the amount of fines for API crush tests performed at 10 kpsi and 15 kpsi for exemplary rod-shaped proppants having different lengths according to the length distribution shown in FIG. 2.

FIG. 4 is a graph showing the amount of fines as a function of rod diameter for API crush tests performed at 5 kpsi, 10 kpsi, and 15 kpsi for exemplary proppants having different diameters.

FIG. 5 is a graph showing the bulk density as a function of proppant length for exemplary proppants.

### DESCRIPTION OF EXEMPLARY EMBODIMENTS

Reference will now be made in detail to exemplary embodiments of the invention.

According to some embodiments, a proppant may include a plurality of proppant particles having a composition including a sintered ceramic. It is believed that alumina (Al₂O₃) adds strength to a proppant, and thus, proppants may be formed from materials having a relatively high alumina content, such as, for example, bauxite. The strength of proppants formed from sintered alumina containing compositions is believed to be due to the mechanical properties of the dense ceramic materials therein.

According to some embodiments, proppants may be intended to be subjected to compressive forces greater than, for example, about 10,000 psi. Such proppants may be formed by, for example, sintering an alumina-containing material, such as, for example, technical grade alumina, bauxite, and/or any other suitable combination of oxides thereof.

For example, alumina-containing materials such as tabular alumina and/or bauxite may be used. According to some embodiments, proppants may be formed from compositions selected from the group consisting of sintered bauxite, sintered kaolin, sintered meta-kaolin, sintered pure or technical grade alumina, sintered alumina-containing slag, and sintered zirconia.

According to some embodiments, the proppants may have an API crush strength of at least about 100 MPa. For example, the proppant may have an API crush strength of at least about 200 MPa. For example, the proppant may have an API crush strength of at least about 250 MPa.

According to some embodiments, the proppants may include a sintered composition including alumina and calcium (e.g., CaO). For example, the proppants may be formed by sintering a composition including titania (TiO₂), iron oxide (e.g., Fe₂O₃), silica (SiO₂), calcium oxide (CaO), and/or alumina. Applicant has surprisingly found that adding calcium (e.g., with a content ranging from about 1% to about 5% by weight) to a composition prior to sintering may result in a sintered proppant exhibiting an improved crush strength performance in certain proppant formulations that also include iron and/or titania. Applicant has also surprisingly found that bauxite with a relatively low alumina content (e.g., ranging from about 60% to about 78% by weight), but having a relatively high combined content of iron oxide and titania, may result in a sintered proppant exhibiting an improved crush strength performance in certain proppant formulations. For example, the combined iron oxide and titania content may be, for example, at least about 11% by weight, at least about 12% by weight, at least about 15% by weight, not greater than about 25% by weight, or a range from about 12% to about 20% by weight.

This may permit the use of lower quality bauxite and/or lower alumina-content bauxite deposits for the production of such proppants, which have properties comparable to proppants made from higher alumina-content bauxite. The calcium-containing material may be supplied in the form of calcium oxide or calcium carbonate (CaCO₃), for example, as shown in Table 1, which shows three alumina-containing formulations for which API crush tests were performed. It is contemplated that the calcium may be supplied from other sources.

TABLE 1

| | CRUSH | | | | | | |
|---|---|---|---|---|---|---|---|
| | TEST | CaCO3 | | | | | |
| Date | average | added | TiO2 | Fe2O3 | SiO2 | CaO | Al2O3 |
| 2009 | 19.8 | NO | 3.1 | 6.5 | 6.5 | 0.05 | 83.85 |
| 2011 | 21.5 | NO | 6.5 | 13.5 | 4.5 | 0.05 | 75.45 |
| 2012/13 | 17.5 | YES | 6.5 | 13.5 | 4.5 | 2.20 | 73.30 |

The crush test results shown in Table 1 are expressed in % fines, and thus, a lower percentage indicates a superior crush test result relative to a higher percentage. As shown in Table 1, the 2011 and 2012/13 samples are identical, except for the replacement of a portion of the alumina with CaO (by the addition of CaCO₃). The 2009 sample is a comparative sample having a higher alumina content but no calcium. As shown in Table 1, the 2012/13 sample has the superior crush test result (17.5%), even though it has the lowest alumina content, which would be expected to result in the worst crush test result. Thus, the Applicant has surprisingly discovered that adding calcium to the composition including alumina, titania, and/or iron exhibits a superior crush test result, even though the alumina content is lower than the 2009 and 2011 samples.

Tables 2-4 below show three examples of alumina-based compositions for preparing proppants, with the compositions shown in Tables 2-4 also including calcium, with the calcium in the compositions shown in Tables 2 and 4 being in the form of CaO and calcium in the composition shown in Table 3 being in the form of anorthite (CaAl₂Si₂O₈).

TABLE 2

| Fused Bead | |
|---|---|
| (normed to | Low Al2O3 |
| 100%) | bauxite + CaCO3 - |
| Name | analysis on the rods |
| Al2O3 | 75.0 |
| Fe2O3 | 10.6 |
| Cr2O3 | 0.15 |
| MnO | 0.03 |
| SiO2 | 5.7 |
| TiO2 | 5.7 |
| ZrO2 | 0.08 |
| MgO | 0.14 |
| CaO | 2.38 |
| K2O | 0.05 |
| Na2O | 0.00 |
| P2O5 | 0.17 |
| SUM | 100.00 |

TABLE 3
XRD
Low Al2O3 bauxite CaCO3

| | |
|---|---|
| 70 | Corundum |
| 0 | Aluminas (gamma, |
| | theta, . . . ) |
| 2 | Mullite |
| 0 | Cristobalite |
| 12 | Armalcolite (Fe) |
| 1 | Tialite |
| 0 | Hematite |
| 0 | Hercynite |
| 0 | Zircon |
| 0 | Rutile |
| 0 | Anatase |
| 0 | Spinel |
| 1 | amorphous |
| 13 | Anorthite |
| 1 | Hibonite |
| 100 | SUM |

TABLE 4

| | Low |
|---|---|
| | Al2O3 |
| Name | bauxite |
| Al2O3 | 74.4 |
| Fe2O3 | 11.3 |
| Cr2O3 | 0.17 |
| MnO | 0.03 |
| SiO2 | 5.8 |
| TiO2 | 6.4 |
| ZrO2 | 0.06 |
| MgO | 0.04 |
| CaO | 0.29 |
| Na2O | 0.00 |
| K2O | 0.06 |
| P2O5 | 0.23 |
| SUM | 99.85 |
| LOI | 1.15 |
| SUM2 | 100.00 |

It is believed that the presence of aluminum titanate (Al₂TiO₅) in the sintered proppants results in improved hardness and toughness of the proppants. The sintered proppant may contain between about 0.2% and about 4% aluminum titanate, such as, for example, between about 0.5% and about 3%, or between about 1% and about 2.5%. According to some embodiments, the aluminum titanate may be formed during sintering when the pre-sintered material includes a small percentage of titania (TiO₂). The titania may be contributed by non-bauxitic sources and/or bauxite. According to some embodiments, the pre-sintered compositions may include by weight between about 0.15% and about 3.5% titania, such as, for example, between about 0.3% and about 2.7% titania, or between about 0.4% and about 2.3% titania. During the sintering process, which may be conducted at a temperature ranging from, for example, about 1,300° C. to about 1,500° C., the titania forms a complex with the alumina to form the aluminum titanate phase.

It is believed that the presence of a small amount of titania results in the presence of an aluminum titanate phase that creates micro-cracks in the structure of the sintered material. It is believed that the micro-cracks reduce the likelihood of the propagation of larger fractures in the structure and result in increasing the toughness of the sintered material.

According to some embodiments, the sintered composition may also be formulated to restrict its silica (SiO₂) content to a specific low level (e.g., preferably less than about 4% by weight, or no more than about 2% by weight). When the level is silica is greater than 4%, it is believed that silica bridges the alumina crystals during the sintering step and makes the ceramic material more fragile and breakable. By limiting the silica content of the proppants, the sintered formulation increases the likelihood of achieving improved strength from a high percentage of alumina (e.g., greater than 92%) reinforced by the formation of aluminum titanate while at the same time minimizing the weakening effects of silica.

Iron oxide, commonly found in bauxite, may also weaken the proppant. Thus, according to some embodiments, the sintered composition contains no more than about 10% by weight iron oxide. According to some embodiments, where a substantial portion of the mixture (e.g., over 80% by weight) to be sintered includes an alumina containing iron oxide (e.g., bauxite) the alumina should preferably not include iron oxide in amounts exceeding about 10% by weight, for example, no more than about 8% by weight. It is believed that this will increase the likelihood that the sintered proppants have superior strength throughout and/or may result in the proppants being able to break into substantially uniform pieces under high closing pressure. This may, in turn, limit the production of excessive, undesirable fines at high closing pressures in subterranean fractures.

A relatively high percentage of alumina in the sintered rods may come from a number of bauxitic and/or non-bauxitic sources. For example, a high-quality bauxite containing a high level of alumina (e.g., 85% or more) may be used as the primary source of alumina for the final composition. Alternatively, a bauxite having less than about 80%, 75%, 70%, 65%, or less by weight of alumina, may be used in combination with calcium. In addition to containing alumina, bauxite may typically contain additional oxides, such as, for example, silica (SiO₂), titania (TiO₂), iron oxide (Fe₂O₃), zirconium oxide (ZrO₂), and/or magnesium oxide (MgO). It is believed that excessive amounts of certain of these oxides may weaken the sintered proppants. Suitable bauxite may come from, for example, the Weipa mine in Australia, or mines in Brazil, China, India, and/or Guinea. According to some embodiments, a non-bauxitic source of alumina, such as, for example, “technical grade alumina” or “pure alumina” may be used to supplement alumina obtained from bauxite. Technical grade alumina may contain, for example, about 98% to about 99% alumina and only a relatively small amount of impurities (e.g., other oxides).

According to some embodiments, a non-bauxitic source of alumina such as, for example, technical grade alumina may be used as the primary source for the alumina contained in the final sintered proppants. A relatively small percentage of bauxite may be used as a supplemental source of alumina, and may contribute a beneficial amount of titania to provide the desired aluminum titanate in the final sintered proppants. Because the bauxite is used in smaller amounts in these embodiments, a bauxite containing higher levels of impurities may be used, so long as the overall amount of the impurities is relatively low in the final sintered proppants.

According to some embodiments, the alumina-containing material (e.g., bauxite) may optionally be sized (e.g., classified) using various milling or grinding techniques, including both attrition grinding and autogenous grinding (i.e., grinding without a grinding medium), and may be ground by either a dry or wet grinding process. The grinding may be accomplished in a single step or may involve multiple grinding steps.

Sizing prior to forming the sintered rods may act to increase the compactness of the feed and may ultimately result in a more crush resistant proppant or anti-flowback additive. According to some embodiments, a jet mill may be used to prepare a first batch of particles having a first particle size distribution. In a jet mill, the particles may be introduced into a stream of fluid, generally air, which circulates the particles and induces collisions between the particles. Using known techniques, the forces in the jet mill may alter the particle size distribution of the particles to achieve a desired distribution. For example, one may vary the type of fluid used in the mill, the shape of the milling chamber, the pressure inside the mill, the number and configuration of fluid nozzles on the mill, and/or whether there is a classifier that removes particles of a desired size while leaving others in the mill for additional milling. The exact configuration may be varied based on the properties of the feed material and/or the desired output properties.

According to some embodiments, after the first batch of alumina-containing particles having the first particle size distribution is prepared, a second batch of particles may be jet-milled to a second particle size distribution. The first and second batch particle size distributions and milling conditions, and the conditions under which they are combined, may be selected to form the desired final particle size distribution of the combined batches prior to sintering. Using this exemplary technique, a bi-modal particle size distribution may be obtained. According to some embodiments, one possible advantage of preparing such bi-modal feed is that it may contain additional relatively fine particles to pack between relatively coarser particles, which may result in increasing the compactness and density prior to sintering. According to some embodiments, three or more batches may be prepared to achieve multi-modal particle size distributions prior to sintering. According to some embodiments, the batches of particles may be combined using any mixing technique known in the art for mixing powders (e.g., dry powders), such as, for example, employing intensive mixers (e.g., Eirich mixers), which may more rapidly produce a relatively homogeneous powder blend. Using this exemplary approach, according to some embodiments, it has surprisingly been discovered that the resultant sintered proppants may achieve relatively superior compactness and/or crush resistance.

According to some embodiments, the alumina-containing material may be sized in a ball mill. Similar to jet milling multiple batches to different particle sizes and mixing them, ball milling may result in a multi-modal particle size distribution, which may improve the compactness of the powder. Acceptable results may be achieved in a single ball-milled batch of particles (i.e., without preparing multiple batches and mixing them). According to some embodiments, multiple batches may be ball-milled and thereafter mixed to form a powder having a desired multi-modal particle size distribution. In some embodiments, batches with two different particle size distributions may be simultaneously milled in the ball mill, resulting in a powder having a multi-modal particle size distribution.

The ball milling process may be either a batch process or a continuous process. According to some embodiments, various additives may be added to the process to increase the yields and/or efficiency of the milling. For example, the additives may act as surface tension modifiers, which may increase the dispersion of fine particles and reduce the chance that the particles adhere to the walls and ball mill media. Suitable additives may include aqueous solutions of modified hydroxylated amines and cement admixtures. In some embodiments, the ball mill may be configured with an air classifier to reintroduce coarser particles back into the mill for a more accurate and controlled milling process. According to some embodiments, ball milling has surprisingly been discovered to result in proppants or anti-flowback additives having improved compactness and/or crush resistance.

While various particle sizes and size distributions may be useful in preparing proppants and anti-flowback additives, according to some embodiments, the pre-milled alumina-containing material may have at least 95% of its particles smaller than about 500 microns as measured by sieving or a Microtrac particle size analyzer, and may have all of its particles smaller than 500 microns. After milling, some embodiments of the material may have a d₅₀ of less than about 10 microns, less than about 5 microns, less than about 3 microns, or less than about 1.5 microns. In some embodiments, the powder may have a d₅₀ ranging from about 1.5 microns to about 2 microns, and/or a ratio of the d₉₀ to the d₁₀ ranging from about 4 to about 8. The d₁₀, d₅₀, and d₉₀ may be measured using a laser microsizer, such as the Malvern Mastersizer 2000. According to some embodiments, the milled material may also have substantially all of its particles smaller than about 30 microns. According to some embodiments, a relatively broad particle size distribution may be preferred over a relatively narrow particle size distribution, as it is believed that a broader distribution may result in an increase of the compactness of the material and/or the crush resistance of the final sintered proppants.

According to some embodiments, the proppants may be prepared by mixing the desired alumina-containing materials with at least one binding agent and/or solvent. The binding agent may include, for example, methyl cellulose, polyvinyl butyrals, emulsified acrylates, polyvinyl alcohols, polyvinyl pyrrolidones, polyacrylics, starch, silicon binders, polyacrylates, silicates, polyethylene imine, lignosulfonates, alginates, similar binding agents, and combinations thereof. The solvent may include, for example, water, alcohols, ketones, aromatic compounds, hydrocarbons, similar solvents, and combinations thereof.

According to some embodiments, other additives known in the art may be added as well. For example, lubricants may be added, such as, for example, ammonium stearates, wax emulsions, elieic acid, Manhattan fish oil, stearic acid, wax, palmitic acid, linoleic acid, myristic acid, lauric acid, similar lubricants, and combinations thereof. According to some embodiments, plasticizers may also be added, including, for example, polyethylene glycol, octyl phthalates, ethylene glycol, similar plasticizers, and combinations thereof.

According to some embodiments, following mixing, the mixture may thereafter be extruded, for example, through a die, to form proppants having a cross-section of a desired shape, for example as explained in more detail herein. The process of extrusion may be performed using extrusion methods known to those skilled in the art. For example, the extrusion process may be a batch process, such as forming the rods using a piston press, or a continuous process using an extruder containing one or more extruder screws. For example, Loomis manufactures a piston press that may be used to batch-produce the proppants, and Dorst and ECT both make extruders that contain one or more extruder screws that may be used in a continuous extrusion production method. Other suitable equipment and manufacturers may be ascertainable by those of skill in the art.

According to some embodiments, following extrusion, the extruded proppants may be dried, for example, at a temperature of about 50° C. degrees or any other effective temperature, and reduced to a desired rod length. Any suitable drying process known in the art may be used. For example, the extruded proppants may be dried using electric and/or gas driers. In some embodiments, the drying process may be performed with a microwave. According to some embodiments, a continuous drying process may be desirable.

According to some embodiments, the reduction to the desired length may be achieved through cutting using, for example, a rotating blade, a cross cutter, a strand cutter, a longitudinal cutter, a cutting mill, a beating mill, a roller, or any other suitable length-reducing mechanism. In some embodiments, the reduction to the desired length may occur as a result of the drying process, for example, forming a mixture of rods having a relatively broad length distribution, and thus, no cutting step may be desired. According to some embodiments, the length reduction may occur during drying as a result of the mechanical properties of the extruded proppant. In such exemplary embodiments, the manufacturing process may be relatively simplified and may reduce manufacturing costs as waste levels may be reduced, cutting equipment may need not be purchased or maintained, and/or less energy may be consumed during the process.

According to some embodiments, for example, where a narrow length distribution is desired, proppants having the desired length may be obtained by any one of various selection methods known to those skilled in the art, including visual and/or mechanical inspection, or sieving. However, some classical sieving methods may tend to break the relatively weaker proppants. However, this may not necessarily be a disadvantage, as the stronger rods may be selected by such sieving. Appropriate selection methods may be determined on a case-by-case basis, and may depend on the goal of the selection process.

According to some embodiments, following selection the proppants may be sintered at temperature ranging from, for example, about 1,300° C. to about 1,700° C. to form sintered proppants that may be suitable for use as proppants or anti-flowback additives. In some embodiments, the sintering temperature may range from about 1,400° C. to about 1,600° C. The sintering equipment may include any suitable equipment known by those skilled in the art, including, for example, rotary or vertical furnaces, or tunnel or pendular sintering equipment.

According to some embodiments, the sintered proppants may be coated with one or more coatings. Applying such coatings may provide various desirable characteristics, including, for example, the ability to control the dispersion of fines that may be generated when the proppants break under injection or closure pressures. Suitable natural and synthetic coatings may include: natural rubber, elastomers such as butyl rubber, and polyurethane rubber, various starches, petroleum pitch, tar, and asphalt, organic semisolid silicon polymers such as dimethyl and methylphenyl silicones, polyhydrocarbons such as polyethylene, polyproplylene, polyisobutylene, cellulose and nitrocellulose lacquers, vinyl resins such as polyvinylacetate, phenolformaldehyde resins, urea formaldehyde resins, acrylic ester resins such as polymerized esters resins of methyl, ethyl and butyl esters of acrylic and alpha-methylacrylic acids, epoxy resins, melamine resins, drying oils, mineral and petroleum waxes, other similar coatings, and combinations thereof. Additional coatings may include urethane resins, phenolic resins, epoxide phenolic resins, polyepoxide phenolic resins, novolac epoxy resins, formaldehyde phenolic resins, other similar resins, and combinations thereof. One or more of these coatings may be applied to the sintered proppants using any known method, including both batch and on-the-fly mixing.

According to some embodiments, the proppants may include rod-shaped particles and/or substantially spherical particles. As used herein, the term “rods” does not necessarily indicate that the cross-section of the proppant particles is circular. Rather, the term “rods” indicates that the proppant particles have a length and a cross-sectional shape taken substantially perpendicular to an axis in the direction of the length. As described herein, the cross-sectional shape may take many forms and may be constant or vary along the length of the proppant particles.

According to some embodiments, the proppant particles may have a regular polygonal cross-sectional shape. For example, the proppant particles may have a hexagonal-shaped cross-section. According to some embodiments, the proppant may have a multifoil-shaped cross-section. For example, the proppant may have a trefoil-shaped cross-section, a sexfoil-shaped cross-section, or a cross-sectional shape selected from the group consisting of quatrefoil, cinquefoil, huitfoil, or higher multifoil.

Some embodiments of proppant particles may have a substantially circular-shaped cross-section defining a diameter. According to some embodiments, the proppant particles may have flower-shaped cross-section defined within an enclosing diameter and defining a number of multifoils or scallop shapes. For example, a flower-shaped cross-section may include six multifoils (i.e., a sexfoil) with exterior radial surfaces of the multifoils tangent to an enclosing diameter. According to some embodiments, the proppant particles may define a cross-shaped cross-section defined within an enclosing diameter and defining a number of multifoils. For example, a cross-shaped cross-section may include four multifoils (i.e., a quatrefoil) with exterior radial surfaces of the multifoils tangent to an enclosing diameter. According to some embodiments, the proppant particles may define a hexagonal-shaped cross-section defined within an enclosing diameter. For example, a hexagonal-shaped cross-section may have exterior surfaces (e.g., corners) tangent to an enclosing diameter. According to some embodiments, a proppant may include a combination of proppant particles having different cross-sectional shapes.

According to some embodiments, a proppant including proppant particles having a non-circular cross-section may exhibit superior desirable properties relative to a proppant including proppant particles having a circular cross-section of the same diameter as the enclosing diameter of the non-circular cross-sectional shape. For example, proppants having proppant particles, each having different cross-sectional shapes were tested according to the API testing standards for porosity of a proppant pack formed by a plurality of the proppant particles of each tested proppant.

Each of the tested proppants were formed by forming a proppant composition, extruding the proppant composition with an extruder, and sintering the extruded proppant composition, which included alumina obtained from bauxite with calcium carbonate added thereto, along with various oxides and additives as outlined herein. As a control, one of the four proppants tested was a proppant including proppant particles having a circular-shaped cross-section having a diameter of 1.78 mm±0.02 mm. The other three tested proppants were formed having a flower-shaped cross-section, a cross-shaped cross-section, and a hexagonal-shaped cross-section, with the cross-sectional shapes having an enclosing diameter of 1.78 mm±0.02 mm; the same as the diameter of the control proppant having a circular-shaped cross-section.

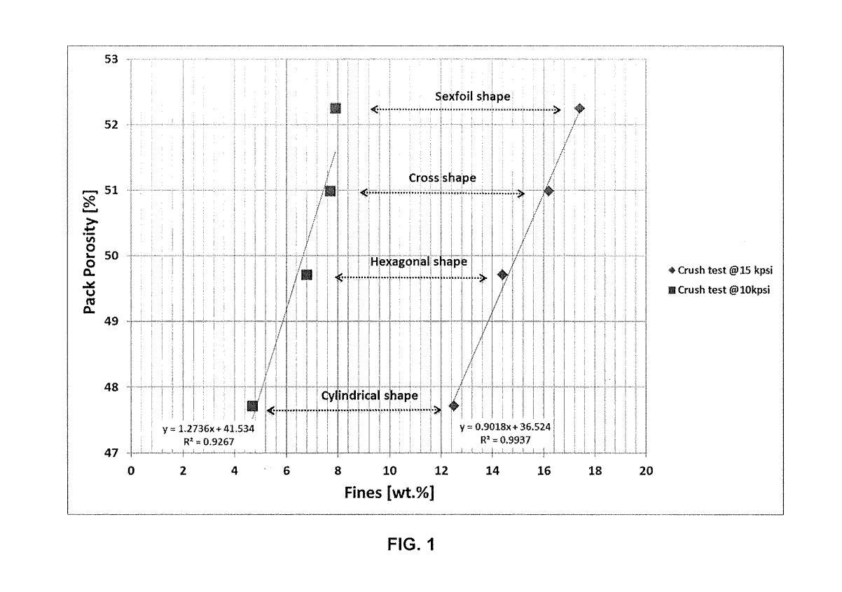

As shown in FIG. 1, all three of the proppants having a non-circular-shaped cross-section exhibited improved pack porosity relative to the control proppant having a circular-shaped cross-section. In particular, the flower-shaped cross-section had the highest pack porosity, the cross-shaped cross-section had the second highest pack porosity, and the hexagonal-shaped cross-section had the third highest pack porosity, with the control proppant having the circular-shaped cross-section ranking last among the tested proppants. The exemplary proppants tested to provide the results shown in FIG. 1 included calcium carbonate.

The length of the proppant particles may have an effect on the crush resistance and/or porosity of the proppant including those proppant particles. For example, according to some embodiments, at least about 90% by weight of the proppant particles have a length of less than about 10 millimeters, for example, a length of less than about 7 millimeters, less than about 5 millimeters, less than about 4 millimeters, less than about 3.75 millimeters, less than about 3.5 millimeters, less than about 3 millimeters, less than about 2.5 millimeters, less than about 2 millimeters, or less than about 1.5 millimeters.

According to some embodiments, the proppant particles may have a length ranging from about 2 millimeters to about 4 millimeters, for example, from about 3 millimeters to about 4 millimeters, or from about 3.5 to about 4 millimeters. According to some embodiments, at least about 10% by weight of the proppant particles may have a length of greater than about 1.2 millimeters, for example, a length of greater than about 1.5 millimeters, a length of greater than about 1.7 millimeters, or a length of greater than about 2.0 millimeters.

According to some embodiments, the proppant particles may have a mean length ranging from about 2 millimeters to about 4 millimeters, for example, a mean length ranging from about 2.0 millimeters to about 2.6 millimeters, a mean length ranging from about 2.2 millimeters to about 2.8 millimeters, a mean length ranging from about 2.6 millimeters to about 3.0 millimeters, a mean length ranging from about 2.0 millimeters to about 2.2 millimeters, a mean length ranging from about 2.2 millimeters to about 2.4 millimeters, a mean length ranging from about 2.4 millimeters to about 2.6 millimeters, a mean length ranging from about 2.6 millimeters to about 2.8 millimeters, or a mean length ranging from about 2.8 millimeters to about 3.0 millimeters.

According to some embodiments, the proppant particles may have a cross-sectional diameter (or an enclosing diameter for non-circular cross-sections), and the proppant particles may have a mean cross-sectional diameter ranging from about 0.1 millimeter to about 2.0 millimeters, for example, a mean cross-sectional diameter ranging from about 1.2 millimeters to about 2.0 millimeters, or a mean cross-sectional diameter ranging from about 1.4 millimeters to about 1.5 millimeters. According to some embodiments, the proppant particles may have a mean cross-sectional diameter of greater than about 0.4 millimeters, for example, a mean cross-sectional diameter of greater than about 0.5 millimeters, or a mean cross-sectional diameter of greater than about 1.2 millimeters. According to some embodiments, the proppant particles may have a mean cross-sectional diameter ranging from about 0.5 millimeters to about 1.5 millimeters, such as, for example, from about 0.5 millimeters to about 1.0 millimeter, from about 0.6 millimeters to about 1.0 millimeter, from about 0.7 millimeters to about 1.0 millimeter, or from about 0.5 millimeters to about 0.8 millimeters.

According to some embodiments, the proppant particles may have a length and a cross-sectional diameter, and an aspect ratio of length to cross-sectional diameter of the proppant particles may be less than about 3, for example, the aspect ratio may be less than about 2.5, less than about 2.0, less than about 1.5, less than about 1.4, less than about 1.2, or less than about 1.1. According to some embodiments, the aspect ratio of the proppant particles may range from about 1.1 to about 3.0, for example, from about 1.5 to about 2.5. According to some embodiments, at least about 10% by weight of the proppant particles may have a length of greater than about the cross-sectional diameter of the respective proppant particles. For example, at least about 10% by weight of the proppant particles may have a length of greater than about 1.1 times the cross-sectional diameter of the respective proppant particles. According to some embodiments, a proppant may include a sintered ceramic, wherein the proppant has an aspect ratio ranging from about 1.5 to about 3, and a multifoil-shaped cross-section. For example, the multifoil-shaped cross-section may be at least one of a trefoil, a quatrefoil, a cinquefoil, a sexfoil, and a huitfoil.

According to some embodiments, at least about 90% by weight of the proppant particles may have a length less than about four times the diameter of the respective proppant particles. For example, at least about 90% by weight of the proppant particles may have a length less than about 3.5 times the cross-sectional diameter of the respective proppant particles, for example, a length less than about three times the cross-sectional diameter of the respective proppant particles.

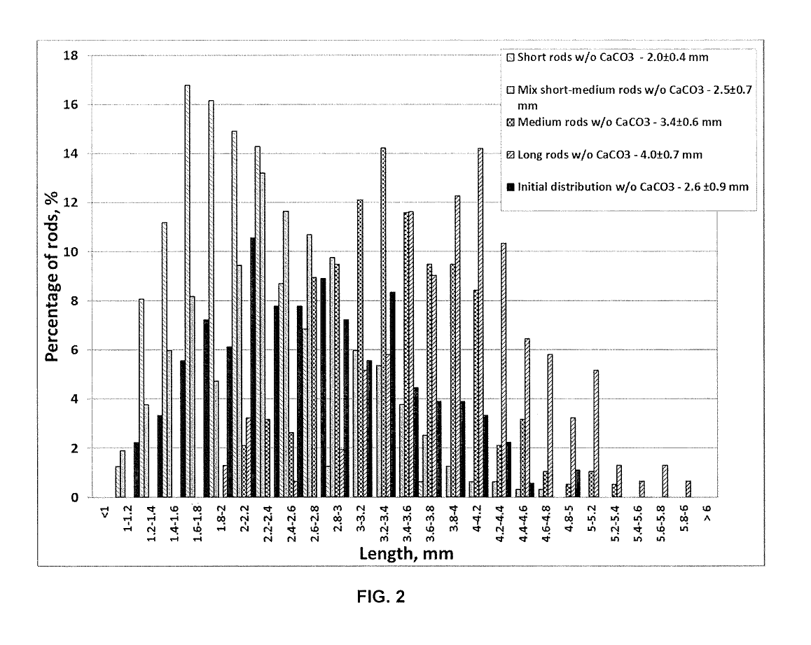

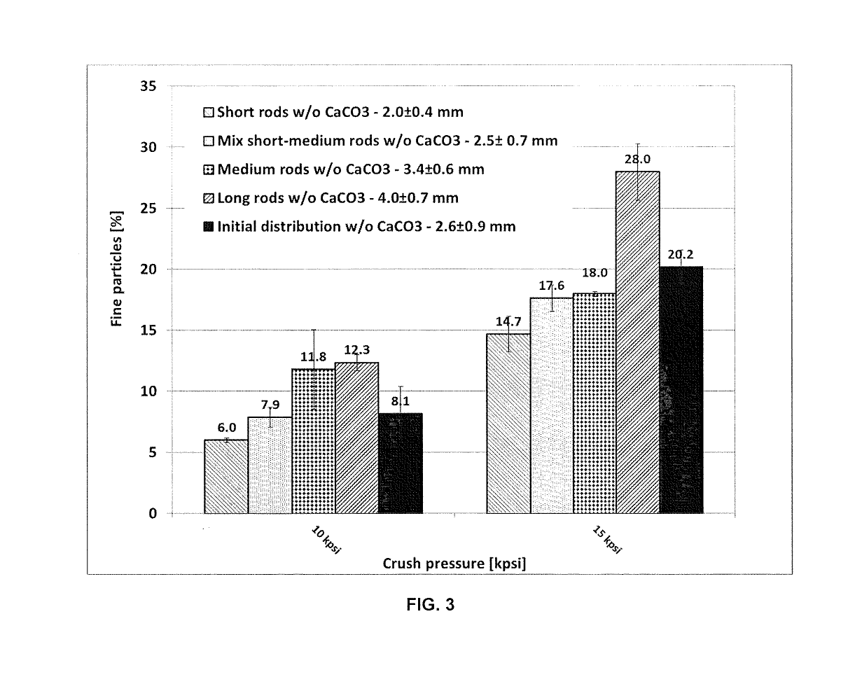

As shown in FIGS. 2 and 3, the length of the proppant particles may affect the crush resistance of the proppant made up of the proppant particles. The example proppant particles (“Rods w/o CaCO3” or rods without calcium carbonate) shown in FIGS. 2 and 3 were tested for crush resistance generally according to the American Petroleum Institute (API) standard testing procedures but using a 1.5 inch diameter test cell instead of a 2 inch diameter test cell, and the effect of length and length distributions is shown in FIGS. 2 and 3. In particular, the crush resistance is shown as “Amount, %” indicating the amount of fines by weight percent of the proppant particles tested. Thus, a lower “Amount” indicates a superior crush resistance relative to a higher “Amount.” Although the length of the proppant particles tested was altered to achieve the test results, other variables (compositions, cross-sectional shape, etc.) were not altered.

The length distribution effect in the proppant particles shown in FIGS. 2 and 3 was assessed on rods without calcium carbonate having a diameter of 14 mesh. From the standard distribution (denoted “Std distribution” in FIGS. 2 and 3), three ranges have been selected (short, medium, and long), then mixed (50% by weight short-50% by weight medium) and compared with the standard distribution. The length distributions and the API crush test results of each range/lot are plotted in FIGS. 2 and 3.

The results shown in FIGS. 2 and 3 show that relatively shorter rods may exhibit a better crush resistance than relatively longer rods. Also, mixing relatively shorter rods and medium-length rods may lead to an intermediate crush resistance. In addition, rods having a length ranging from about 3.5 millimeters to about 4 millimeters may have a relatively poor crush resistance, particularly as compared to rods having a shorter length. Also, relatively longer rods present in a standard distribution may significantly affect the amount of fines after crush even in low concentrations. The standard distribution has an average length of 2.64 millimeters, which is comparable to the mix between the short and the medium-length rods. However, the fines after API crush at 15 kpsi is 3 wt. % higher due to the presence of long rods even in low concentrations.

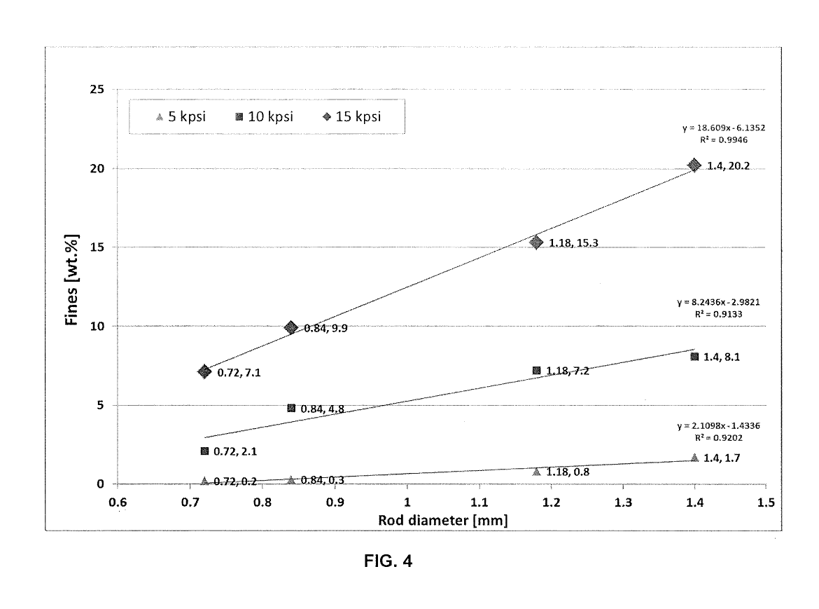

Table 5 below and FIG. 4 show that the diameter of the proppant particles may affect the crush resistance of the proppant made up of the proppant particles. As used herein “diameter” does not necessarily indicate that the proppant particles have a circular cross-section. Rather, although “diameter” may be used to described a circular-shaped cross-section, as noted previously it may also be used to describe cross-sections similar to a circular cross-section, and wherein the “diameter” defines a circle within which the cross-section closely fits (i.e., the enclosing diameter).

TABLE 5

| | Sieving | |
|---|---|---|
| Size/opening | After API crush | Ratio |
| # 14 | # 18 | 1.41 |
| 1410 microns | 1000 microns | |
| # 16 | # 20 | 1.39 |
| 1180 microns | 850 microns | |
| # 20 | # 30 | 1.41 |
| 850 microns | 600 microns | |
| # 24 mesh | # 35 | 1.47 |
| 736 microns | 500 microns | |

Table 5 shows the effect of the diameter on rods without calcium carbonate for diameters of 14 mesh, 16 mesh, 20 mesh, and 24 mesh. As the diameter is different, the sieving conditions after crush are also different to keep a diameter/sieve opening ratio constant. The sieve opening used for each rod diameter is given in the Table 5.

The API crush test results shown in FIG. 4 show that relatively smaller diameters have better API crush performance. This behavior is similar to spherical proppant particles where the API crushes are better with smaller beads because there are relatively more contact points with the crushing surface as compared to spherical particles having a larger diameter. The test results also show that for each diameter the amount of fines varies linearly with the presence of crush.

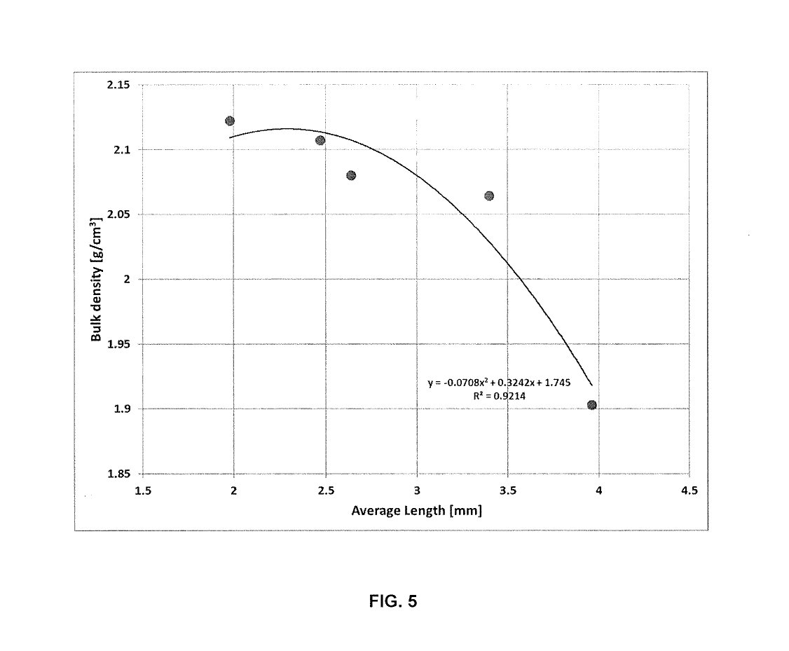

These results show that relatively shorter rods have better mechanical properties than longer rods and that very long rods have a negative effect in terms of crush resistance. However, short rods may also have a higher bulk density (or lower pack porosity), which should affect negatively the conductivity (e.g., see FIG. 5) when compared to relatively longer rods. The exemplary rod-shaped proppants providing the results shown in FIGS. 2-5 did not include calcium carbonate.

According to some embodiments, a rod-shaped proppant may include a sintered ceramic. The proppant may have an aspect ratio ranging from about 1.5 to about 3, an apparent specific gravity ranging from about 2.0 to about 4.0, an API crush value of less than 22% fines at 15,000 psi, and a pack porosity of greater than 49%.

According to some embodiments, the proppant may have an aspect ratio ranging from about 1.5 to about 2. According to some embodiments, the proppant may have an apparent specific gravity ranging from about 2.0 to about 3.0, such as, for example, from about 2.4 to about 2.75. According to some embodiments, the proppant may have an apparent specific gravity ranging from about 3.0 to about 4.0, such as, for example, from about 3.2 to about 3.8, from about 3.4 to about 3.7, or from about 3.3 to about 3.5. According to some embodiments, the proppant may have an API crush value of less than 20% fines at 15,000 psi. According to some embodiments, the proppant may have a pack porosity of greater than 50%. According to some embodiments, the proppant may have an average diameter ranging from about 0.5 millimeter to about 2 millimeters. According to some embodiments, the proppant may have an average length of about 2 millimeters to about 4 millimeters. According to some embodiments, the proppant may have a bulk density ranging from about 0.5 g/cm³ to about 2.5 g/cm³. For example, the proppant may have a bulk density ranging from about 1.2 g/cm³ to about 2.5 g/cm³, such as, for example, from about 1.7 g/cm³ to about 2.2 g/cm³, or from about 1.8 g/cm³ to about 2.0 g/cm³. According to some embodiments, the proppant may be coated with a natural or synthetic coating.

Following hydraulic fracturing treatments, proppant flowback continues to be a challenging problem throughout the oil and gas industry. This may be especially true in high rate gas wells, where the presence of proppant in the high velocity production stream may result in abrasive damage to downstream production equipment. In turn, this damage may manifest itself in production-related issues, such as, for example, cutting-out chokes, and may raise safety concerns regarding damage to valves and other production hardware (e.g., elbows, etc.). Beyond these possible immediate drawbacks, the produced proppant may require separation from the production fluids and then at some later stage, appropriate disposal. Despite typically lower velocities, similar challenges may occur in high rate oil wells, where the higher fluid viscosity is the primary driver for proppant flowing back to surface facilities. Regardless of the producing environment, all the challenges associated with proppant flowback may become further exacerbated for offshore wells and platforms, where safety and costs may be at a higher premium. Even in low production onshore wells (e.g., “pumpers”), proppant flowback may still present challenges, for example, where proppant inflow may damage to downhole pumps and may limit production due to wellbore sand-fill.

Over the years, numerous techniques, products, and additives have been developed in an attempt to control proppant flowback, but none of these have had universal success. In addition, many of the products and additives may have additional drawbacks, such as, for example, reducing the proppant pack conductivity, which may be even more limiting in the high production near the wellbore region where such products may be typically deployed. Of these products, resin-coated proppants are most commonly used, but whether pre-coated before delivery or coated on-the-fly during the fracturing treatment, the presence of grain-to-grain resin bonds may occupy interstitial porosity, and thus, may reduce the proppant pack conductivity. In addition, many of these resin-coated proppants may require temperature and pressure, or a combination thereof, in order to “set-up” under downhole conditions. Such reactive resins may also impact the fracture fluid chemistry, possibly causing inefficiencies with polymer cross-linker and breaker additives. On-the-fly treatments may require extra equipment and personnel on location, and as such, may carry additional service charges. Finally, many of these resin systems may present heightened environmental concerns, especially in sensitive offshore locations such as, for example, the North Sea. Other flowback control products may include proppant additives, such as deformable particles and fibers, which may “mechanically” increase the proppant pack stability. However, as with resins, such additives may tend to occupy the pore spaces between the proppant grains and in doing so, may also reduce fracture conductivity.

A proppant that may be capable of providing both flowback control and simultaneously enhancing fracture conductivity in the near wellbore region may be desirable. According to some embodiments disclosed herein, rod-shaped proppants may serve to provide such characteristics.

Considering some limitations associated with most proppant flowback control products, such as, for example, conductivity reduction, job complexity, and added cost, some operators may choose to only treat a portion of the fracture that renders flowback control particularly desirable. This may typically be achieved by, for example, “tailing in” with the product or additive in the latter stages of the fracturing treatment to provide flowback control in the near wellbore region and, more specifically, where the fracture connects to the wellbore. This so-called “tail-in” technique may often be based on a “first in last out” procedure, implying that proppant pumped into the fracture in the early stages will be placed out towards the fracture tip, and proppant pumped into the fracture relatively later in the process will be placed close to the wellbore. Since these assumptions are often flawed, only pumping the whole fracture treatment with the flowback control product may substantially ensure protection at the wellbore. But as already mentioned, reality often dictates otherwise, and thus, many operators may choose to only treat the latter stages of the fracture treatment, hoping that the near wellbore region sufficiently incorporates the flowback control product/additive. A tail-in may be defined as any latter part or stage of the fracturing treatment that is judged to be a change from, or different from, the earlier stages. Although an extreme example, there may be a desire to place 1% of a product at the beginning of a fracture and thereafter “tail-in” the remaining 99% with some other product. More typically, tail-ins tend to be of the order of less than 50% by weight of the total fracture treatment. More typically, especially for proppant flowback control, tail-ins may be designed at about 20-30% by weight of the total treatment, which may be considered a good balance between overusing a product versus ensuring near wellbore coverage.

Since conductivity reduction may not present a disadvantage when using a rod-shaped proppant, limitations to designing a fracture treatment with a tail-in of rod-shaped proppants may more likely relate to other operational constraints. An advantage of using a rod-shaped proppant in many sizes of tail-in, whether it be 50%, 40%, 30%, 25%, 20%, or even only 15% by weight of the treatment, would be the improved likelihood of flowback control while also providing increased conductivity in the portion of the fracture (near wellbore) that may see the highest production flow rates and greatest drawdown pressures.

According to some embodiments, tailing-in with a rod-shaped proppants may not limit its use in other stages of the fracture treatment, where, for example, it may be advantageous to pump alternate treatment stages of rod-shaped proppants and non-rod-shaped proppants. According to some embodiments, it may also be operationally advantageous to pump ratios or mixtures of the rod-shaped proppants with conventional proppants, for example, to provide some lesser/limited benefit of flowback control, balanced against other operational challenges or requirements.

As mentioned previously, having a universal product for proppant flowback control in all reservoir and well situations may be challenging. Even when such proppant flowback control products/additives are incorporated, the most extreme well conditions (e.g., high rates, cyclic stresses, and/or HT/HP) lend toward some degree of proppant flowback.

Despite the bulk proppant pack according to some embodiments being stable versus conventional proppants (e.g., spherical proppants), laboratory testing on a rod-shaped proppants has shown that small amounts of proppant can be produced from the perforation tunnel and a limited peripheral zone. This observation may provide additional production benefit in field applications where a small amount of proppant flowback can be tolerated. In “cleaning out” the perforation and peripheral zone, this may remove a possible production choke right at the fracture-wellbore communication point. A further possible benefit, observed during these high rate proppant flowback tests, may be the formation of a stable production channel through the proppant pack at “failure.” Conventional spherical proppants may typically fail catastrophically during flowback tests, often producing the majority of the proppant pack in an instant and allowing the fracture to significantly close. Such loss of width may undesirably equate to an unpropped hydraulic fracture, pinching-off in the near wellbore region. Since the rod-shaped proppant appears to form a stable channel through the proppant pack, if such volumes of proppant flowback can be tolerated operationally from a well, then forming even small highly conductive channels within the propped hydraulic fracture treatment could provide significant production benefit.

Similar to a cylindrical rod-shaped proppant's benefit of proppant flowback control and increased conductivity, other cross-sectional shapes of rod-shaped proppants have been shown to provide increases in conductivity over spherical proppants. In addition, other cross-sectional shapes with flat edges, for example, a hexagonal cross-sectional shape, may provide further proppant flowback resistance. Several laboratory studies have documented the inherent instability associated with spherical proppants during proppant flowback tests, and this has been ascribed to the limited friction between the curved surfaces of the spherical proppants. Although the macro-structure of randomly packed rod-shaped proppants may provide enhanced mechanical stability and greater proppant flowback resistance, the rod-shaped proppants may still have a predominantly circular cross-section, and the friction between individual rods may not be optimized for flowback resistance. This inter-particle frictional stability might be further increased by using rod-shaped proppants with flat surfaces or multiple contact points, thus possibly providing additional flowback resistance at the micro-structure level, as well as possibly maintaining the macro-structure stability of the randomly packed rod-shaped aspect ratio.

For the avoidance of doubt, the present application is directed to the exemplary subject matter described in the following numbered paragraphs (i.e., numbered paragraphs 1-103 (also denoted by [105]-[207])).

1. A proppant comprising a sintered ceramic, wherein the sintered ceramic has a composition comprising: an alumina content ranging from about 60% to about 78% by weight; an iron oxide content ranging from about 5% to about 20% by weight; a silica content ranging from about 1% to about 10% by weight; a titania content ranging from about 2% to about 8% by weight; and a combined iron oxide and titania content of at least about 11% by weight.

2. The proppant according to numbered paragraph 1 (also denoted by [105]), wherein the combined iron oxide and titania content is at least about 12% by weight.

3. The proppant according to any preceding numbered paragraph (i.e., paragraphs 1 and 2 (also denoted by [105] and [106])) of claim 1, wherein the combined iron oxide and titania content is at least about 15% by weight.

4. The proppant according to any preceding numbered paragraph, wherein the combined iron oxide and titania content is not greater than about 25% by weight.

5. The proppant according to any preceding numbered paragraph, wherein the combined iron oxide and titania content ranges from about 12% to about 20% by weight.

6. The proppant according to any preceding numbered paragraph, wherein the proppant comprises proppant particles having a length and a cross-sectional diameter, and wherein the proppant particles have an aspect ratio of length to cross-sectional diameter ranging from about 1.5 to about 3.

7. The proppant according to any preceding numbered paragraph, wherein the proppant has an apparent specific gravity ranging from about 2.0 to about 4.0, such as, for example, from about 2.4 to about 2.75, from about 3.2 to about 3.8, from about 3.4 to about 3.7, or from about 3.3 to about 3.5.

8. The proppant according to any preceding numbered paragraph, wherein the proppant has an API crush value of less than 22% fines at 15,000 psi.

9. The proppant according to any preceding numbered paragraph, wherein the proppant has a pack porosity of greater than 49%.

10. The proppant according to any preceding numbered paragraph, wherein the proppant has a multifoil-shaped cross-section.

11. The proppant according to any preceding numbered paragraph, wherein the proppant has a crush strength of at least about 100 MPa, such as, for example, at least about 200 MPa or at least about 250 MPa.

12. The proppant according to any preceding numbered paragraph, the proppant comprising a sintered ceramic, wherein the sintered ceramic has a composition comprising: an alumina content ranging from about 60% to about 78% by weight; an iron oxide content ranging from about 5% to about 20% by weight; a silica content ranging from about 1% to about 10% by weight; and a calcium oxide content ranging from about 1% to about 5% by weight.

13. The proppant according to any preceding numbered paragraph, wherein the alumina content ranges from about 70% to about 78% by weight.

14. The proppant according to any preceding numbered paragraph, wherein the iron oxide content ranges from about 8% to about 15% by weight.

15. The proppant according to any preceding numbered paragraph, wherein the titania content ranges from about 2% to about 8% by weight.

16. The proppant according to any preceding numbered paragraph, wherein the proppant has a combined iron oxide and titania content ranging from about 12% to about 20% by weight.

17. The proppant according to any preceding numbered paragraph, wherein the proppant comprises proppant particles having a length and a cross-sectional diameter, and wherein the proppant particles have an aspect ratio of length to cross-sectional diameter ranging from about 1.5 to about 3.

18. The proppant according to any preceding numbered paragraph, wherein the proppant has an apparent specific gravity ranging from about 2.0 to about 4.0, such as, for example, from about 2.4 to about 2.75, from about 3.2 to about 3.8, from about 3.4 to about 3.7, or from about 3.3 to about 3.5.

19. The proppant according to any preceding numbered paragraph, wherein the proppant has an API crush value of less than 22% fines at 15,000 psi.

20. The proppant according to any preceding numbered paragraph, wherein the proppant has a pack porosity of greater than 49%.

21. The proppant according to any preceding numbered paragraph, wherein the proppant has a multifoil-shaped cross-section.

22. The proppant according to any preceding numbered paragraph, wherein the proppant has a crush strength of at least about 100 MPa, such as, for example, at least about 200 MPa or at least about 250 MPa.

23. A ceramic precursor composition suitable for use in making the proppant according to any preceding numbered paragraph, the ceramic precursor composition comprising: at least about 80% by weight on a dry basis of a bauxite ore comprising an alumina content ranging from about 55% to about 78% by weight and an iron oxide content ranging from about 5% to about 20% by weight; and an alkaline earth carbonate content ranging from about 1% to about 5% by weight.

24. The ceramic precursor according to any preceding numbered paragraph, further comprising a titania content ranging from about 2% to about 8% by weight.

25. The ceramic precursor according to any preceding numbered paragraph, further comprising a sufficient alumina content to bring the total alumina content of the ceramic precursor composition into the range of from about 70% to about 78% by weight.

26. The ceramic precursor according to any preceding numbered paragraph, wherein the iron oxide content ranges from about 8% to about 15% by weight.

27. The ceramic precursor according to any preceding numbered paragraph, wherein the proppant has a combined iron oxide and titania content ranging from about 12% to about 20% by weight.

28. A method for making a sintered ceramic proppant according to any preceding numbered paragraph, the method comprising: forming a ceramic precursor composition by admixing: (i) at least about 80% by weight on a dry basis of a bauxite ore having an alumina content ranging from about 55% to about 78% by weight and an iron oxide content ranging from about 5% to about 20% by weight, and (ii) about 1% to about 5% by weight of an alkaline earth carbonate; shaping the ceramic precursor composition into a desired shape; and sintering the shaped ceramic precursor composition to produce a sintered ceramic proppant.

29. The method according to any preceding numbered paragraph, wherein the ceramic precursor composition further comprises a titania content ranging from about 2% to about 8% by weight.

30. The method according to any preceding numbered paragraph, wherein the ceramic precursor composition has an iron oxide content ranging from about 8% to about 15% by weight.

31. The method according to any preceding numbered paragraph, wherein the shaped ceramic precursor has a Krumbein sphericity of at least about 0.5.

32. The method according to any preceding numbered paragraph, wherein the shaped ceramic precursor has a Krumbein roundness of at least about 0.5.

33. The method according to any preceding numbered paragraph, wherein the shaped ceramic precursor is rod-shaped.

34. The method according to any preceding numbered paragraph, wherein the rod-shaped ceramic precursor has a multi-foil shaped cross-section.

35. A rod-shaped proppant comprising a sintered ceramic, wherein the proppant has: an aspect ratio ranging from about 1.5 to about 3; an apparent specific gravity ranging from about 2.0 to about 4.0; an API crush value of less than 22% fines at 15,000 psi; and a pack porosity of greater than 49%.

36. The proppant according to any preceding numbered paragraph, wherein the proppant has a regular polygonal-shaped cross-section.

37. The proppant according to any preceding numbered paragraph, wherein the proppant has a hexagonal-shaped cross-section.

38. The proppant according to any preceding numbered paragraph, wherein the proppant has a multifoil-shaped cross-section.

39. The proppant according to any preceding numbered paragraph, wherein the proppant has a trefoil-shaped cross-section.

40. The proppant according to any preceding numbered paragraph, wherein the proppant has a sexfoil-shaped cross-section.

41. The proppant according to any preceding numbered paragraph, wherein the proppant has a cross-sectional shape selected from the group consisting of quatrefoil, cinquefoil, huitfoil, or higher multifoil.

42. The proppant according to any preceding numbered paragraph, wherein the proppant has an aspect ratio ranging from about 1.5 to about 2.

43. The proppant according to any preceding numbered paragraph, wherein the proppant has an apparent specific gravity ranging from about 2.4 to about 4.0, such as, for example, from about 2.4 to about 2.75, from about 3.2 to about 3.8, from about 3.4 to about 3.7, or from about 3.3 to about 3.5.

44. The proppant according to any preceding numbered paragraph, wherein the proppant has an API crush value of less than 20% fines at 15,000 psi.

45. The proppant according to any preceding numbered paragraph, wherein the proppant has a pack porosity of greater than 50%.

46. The proppant according to any preceding numbered paragraph, wherein the proppant has an average diameter ranging from about 0.5 millimeter to about 2 millimeters.

47. The proppant according to any preceding numbered paragraph, wherein the proppant has an average length ranging from about 2 millimeters to about 4 millimeters.

48. The proppant according to any preceding numbered paragraph, wherein the proppant has a bulk density ranging from about 0.5 g/cm³ to about 2.5 g/cm³.

49. The proppant according to any preceding numbered paragraph, wherein the proppant has a bulk density ranging from about 1.2 g/cm³ to about 1.9 g/cm³.

50. The proppant according to any preceding numbered paragraph, wherein the proppant is coated with a natural or synthetic coating.

51. The proppant according to any preceding numbered paragraph, wherein the proppant comprises a composition selected from the group consisting of sintered bauxite, sintered kaolin, sintered meta-kaolin, sintered bauxitic kaolin, sintered pure or technical grade alumina, sintered alumina-containing slag, and sintered zirconia.

52. The proppant according to any preceding numbered paragraph, wherein the proppant comprises rod-shaped particles and substantially spherical particles.

53. The proppant according to any preceding numbered paragraph, wherein the proppant has a crush strength of at least about 100 MPa.

54. The proppant according to any preceding numbered paragraph, wherein the proppant has a crush strength of at least about 200 MPa, such as, for example, at least about 250 MPa.

55. The proppant according to any preceding numbered paragraph, wherein the proppant particles have a length, and wherein at least about 90% by weight of the proppant particles have a length of less than about 10 millimeters.

56. The proppant according to any preceding numbered paragraph, wherein at least about 90% by weight of the proppant particles have a length of less than about 7 millimeters.

57. The proppant according to any preceding numbered paragraph, wherein at least about 90% by weight of the proppant particles have a length of less than about 5 millimeters.

58. The proppant according to any preceding numbered paragraph, wherein at least about 90% by weight of the proppant particles have a length of less than about 4 millimeters.

59. The proppant according to any preceding numbered paragraph, wherein at least about 90% by weight of the proppant particles have a length of less than about 3.75 millimeters.

60. The proppant according to any preceding numbered paragraph, wherein at least about 90% by weight of the proppant particles have a length of less than about 3.5 millimeters.

61. The proppant according to any preceding numbered paragraph, wherein at least about 90% by weight of the proppant particles have a length of less than about 3 millimeters.

62. The proppant according to any preceding numbered paragraph, wherein at least about 90% by weight of the proppant particles have a length of less than about 2.5 millimeters.

63. The proppant according to any preceding numbered paragraph, wherein at least about 90% by weight of the proppant particles have a length of less than about 2 millimeters.

64. The proppant according to any preceding numbered paragraph, wherein at least about 90% by weight of the proppant particles have a length of less than about 1.5 millimeters.

65. The proppant according to any preceding numbered paragraph, wherein the proppant particles have a length, and wherein the length of the proppant particles ranges from about 2 millimeters to about 4 millimeters.

66. The proppant according to any preceding numbered paragraph, wherein the length of the proppant particles ranges from about 3 millimeters to about 4 millimeters.

67. The proppant according to any preceding numbered paragraph, wherein the length of the proppant particles ranges from about 3.5 to about 4 millimeters.

68. The proppant according to any preceding numbered paragraph, wherein the proppant particles have a length, and wherein at least about 10% by weight of the proppant particles have a length of greater than about 1.2 millimeters.

69. The proppant according to any preceding numbered paragraph, wherein at least about 10% by weight of the proppant particles have a length of greater than about 1.5 millimeters.

70. The proppant according to any preceding numbered paragraph, wherein at least about 10% by weight of the proppant particles have a length of greater than about 1.7 millimeters.

71. The proppant according to any preceding numbered paragraph, wherein at least about 10% by weight of the proppant particles have a length of greater than about 2.0 millimeters.

72. The proppant according to any preceding numbered paragraph, wherein the proppant particles have a length, such that the proppant particles have a mean length ranging from about 2 millimeters to about 4 millimeters.

73. The proppant according to any preceding numbered paragraph, wherein the proppant particles have a mean length ranging from about 2.0 millimeters to about 2.6 millimeters.

74. The proppant according to any preceding numbered paragraph, wherein the proppant particles have a mean length ranging from about 2.2 millimeters to about 2.8 millimeters.

75. The proppant according to any preceding numbered paragraph, wherein the proppant particles have a mean length ranging from about 2.6 millimeters to about 3.0 millimeters.

76. The proppant according to any preceding numbered paragraph, wherein the proppant particles have a mean length ranging from about 2.0 millimeters to about 2.2 millimeters.

77. The proppant according to any preceding numbered paragraph, wherein the proppant particles have a mean length ranging from about 2.2 millimeters to about 2.4 millimeters.

78. The proppant according to any preceding numbered paragraph, wherein the proppant particles have a mean length ranging from about 2.4 millimeters to about 2.6 millimeters.

79. The proppant according to any preceding numbered paragraph, wherein the proppant particles have a mean length ranging from about 2.6 millimeters to about 2.8 millimeters.

80. The proppant according to any preceding numbered paragraph, wherein the proppant particles have a mean length ranging from about 2.8 millimeters to about 3.0 millimeters.

81. The proppant according to any preceding numbered paragraph, wherein the proppant particles have a cross-sectional diameter, and wherein the proppant particles have a mean cross-sectional diameter ranging from about 0.1 millimeter to about 2.0 millimeters.

82. The proppant according to any preceding numbered paragraph, wherein the proppant particles have a mean cross-sectional diameter ranging from about 1.2 millimeters to about 2.0 millimeters.

83. The proppant according to any preceding numbered paragraph, wherein the proppant particles have a mean cross-sectional diameter ranging from about 1.4 millimeters to about 1.5 millimeters.

84. The proppant according to any preceding numbered paragraph, wherein the proppant particles have a cross-sectional diameter, and wherein the proppant particles have a mean cross-sectional diameter of greater than about 0.4 millimeters.

85. The proppant according to any preceding numbered paragraph, wherein the proppant particles have a mean cross-sectional diameter of greater than about 0.5 millimeters.

86. The proppant according to any preceding numbered paragraph, wherein the proppant particles have a mean cross-sectional diameter of greater than about 1.2 millimeters.

87. The proppant according to any preceding numbered paragraph, wherein the proppant particles have a length and a cross-sectional diameter, and wherein an aspect ratio of length to cross-sectional diameter of the proppant particles is less than about 3.

88. The proppant according to any preceding numbered paragraph, wherein the aspect ratio of length to cross-sectional diameter of the proppant particles is less than about 2.5.

89. The proppant according to any preceding numbered paragraph, wherein the aspect ratio of length to cross-sectional diameter of the proppant particles is less than about 2.0.

90. The proppant according to any preceding numbered paragraph, wherein the aspect ratio of length to cross-sectional diameter of the proppant particles is less than about 1.5.

91. The proppant according to any preceding numbered paragraph, wherein the aspect ratio of length to cross-sectional diameter of the proppant particles is less than about 1.4.

92. The proppant according to any preceding numbered paragraph, wherein the aspect ratio of length to cross-sectional diameter of the proppant particles is less than about 1.2.

93. The proppant according to any preceding numbered paragraph, wherein the aspect ratio of length to cross-sectional diameter of the proppant particles is less than about 1.1.

94. The proppant according to any preceding numbered paragraph, wherein the proppant particles have a length and a cross-sectional diameter, and wherein an aspect ratio of length to cross-sectional diameter of the proppant particles ranges from about 1.2 to about 3.0.

95. The proppant according to any preceding numbered paragraph, wherein the aspect ratio of length to cross-sectional diameter of the proppant particles ranges from about 1.5 to about 2.5.

96. The proppant according to any preceding numbered paragraph, wherein the proppant particles have a length and a cross-sectional diameter, and wherein at least about 10% by weight of the proppant particles have a length of greater than about the diameter of the respective proppant particles.

97. The proppant according to any preceding numbered paragraph, wherein at least about 10% by weight of the proppant particles have a length of greater than about 1.1 times the cross-sectional diameter of the respective proppant particles.

98. The proppant according to any preceding numbered paragraph, wherein the proppant particles have a length and a cross-sectional diameter, and wherein at least about 90% by weight of the proppant particles have a length less than about four times the cross-sectional diameter of the respective proppant particles.

99. The proppant according to any preceding numbered paragraph, wherein at least about 90% by weight of the proppant particles have a length less than about 3.5 times the cross-sectional diameter of the respective proppant particles.

100. The proppant according to any preceding numbered paragraph, wherein at least about 90% by weight of the proppant particles have a length less than about three times the cross-sectional diameter of the respective proppant particles.

101. The proppant according to any preceding numbered paragraph comprising a sintered ceramic, wherein the proppant comprises proppant particles having a length and a cross-sectional diameter, and wherein the proppant particles have: an aspect ratio of length to cross-sectional diameter ranging from about 1.5 to about 3; and a multifoil-shaped cross-section.

102. The proppant according to any preceding numbered paragraph, wherein the multifoil-shaped cross-section is at least one of a trefoil, a quatrefoil, a cinquefoil, a sexfoil, and a huitfoil.

103. A method of using the proppant according to any preceding numbered paragraph, the method comprising: adding proppant to a well bore; and tailing-in an amount of the proppant added ranging from about 20% by weight to about 50% by weight of the total proppant added to the well bore.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1-119. (canceled)

120. A rod-shaped proppant comprising a sintered ceramic, wherein the proppant has:
an aspect ratio ranging from about 1.5 to about 3;
an apparent specific gravity ranging from about 2.0 to about 4.0;
an API crush value of less than 22% fines at 15,000 psi; and
a pack porosity of greater than 49%.

121. The proppant of claim 120, wherein the proppant has a regular polygonal-shaped cross-section.

122. The proppant of claim 120, wherein the proppant has a trefoil-shaped cross-section.

123. The proppant of claim 120, wherein the proppant has an aspect ratio ranging from about 1.5 to about 2.

124. The proppant of claim 120, wherein the proppant has a bulk density ranging from about 1.2 g/cm³ to about 1.9 cm³.

125. The proppant of claim 120, wherein the proppant comprises rod-shaped particles and substantially spherical particles.

126. The proppant of claim 120, wherein the proppant has a crush strength of at least about 100 MPa.

127. The proppant of claim 120, wherein the proppant particles have a length, and wherein at least about 90% by weight of the proppant particles have a length of less than about 10 millimeters.

128. The proppant of claim 127, wherein at least about 90% by weight of the proppant particles have a length of less than about 4 millimeters.

129. The proppant of claim 127, wherein at least about 90% by weight of the proppant particles have a length of less than about 3 millimeters.

130. The proppant of claim 120, wherein the proppant particles have a length, and wherein at least about 10% by weight of the proppant particles have a length of greater than about 1.2 millimeters.

131. The proppant of claim 120, wherein the proppant particles have a length, such that the proppant particles have a mean length ranging from about 2 millimeters to about 4 millimeters.

132. The proppant of claim 131, wherein the proppant particles have a mean length ranging from about 2.0 millimeters to about 2.6 millimeters.

133. The proppant of claim 120, wherein the proppant particles have a cross-sectional diameter, and wherein the proppant particles have a mean cross-sectional diameter ranging from about 0.1 millimeter to about 2.0 millimeters.

134. The proppant of claim 120, wherein the proppant particles have a length and a cross-sectional diameter, and wherein at least about 90% by weight of the proppant particles have a length less than about four times the cross-sectional diameter of the respective proppant particles.

135. The proppant of claim 134, wherein at least about 90% by weight of the proppant particles have a length less than about three times the cross-sectional diameter of the respective proppant particles.

136. A proppant comprising a sintered ceramic, wherein the proppant comprises proppant particles having a length and a cross-sectional diameter, and wherein the proppant particles have:
an aspect ratio of length to cross-sectional diameter ranging from about 1.5 to about 3; and
a multifoil-shaped cross-section.

137. The proppant of claim 136, wherein the multifoil-shaped cross-section is at least one of a trefoil, a quatrefoil, a cinquefoil, a sexfoil, and a huitfoil.
